(19) United States
(12) Patent Application Publication
(10) Pub. No.: US 2008/0065698 A1
(43) Pub. Date: Mar. 13, 2008

(54) METHOD AND APPARATUS FOR EMULATING ALTERNATE DATA STREAMS ACROSS HETEROGENEOUS FILE SYSTEMS

(76) Inventors: Steven Michael French, Austin, TX (US); David John Kleikamp, Cedar Park, TX (US); Theodore Yue Tak Tso, Medford, MA (US)

Correspondence Address: IBM CORP (YA);C/O YEE & ASSOCIATES PC, P.O. BOX 802333, DALLAS, TX, 75380, US

(21) Appl. No.: 11/467,424

(22) Filed: Aug. 25, 2006

(51) Int. Cl. G06F 17/30

(52) U.S. Cl. 707/200

(57) ABSTRACT

Illustrative embodiments show a computer implemented method, apparatus, and computer usable program code for supporting a stream. A stream request is received. A file name associated with the stream is created. Responsive to receiving the stream request, the stream is stored as a file in a directory tree in the file system.

### BACKGROUND OF THE INVENTION

1. Field of the Invention

The present invention relates generally to a data processing system and in particular to a method and apparatus for processing data. Still more particularly, the present invention relates to a computer implemented method, apparatus, and computer usable program code for storing supporting data streams across file systems.

2. Description of the Related Art

An area of concern is the ability of manufacturers to build data processing systems that uniformly implement a particular feature. Often, some aspects of data processing systems of different manufacturers fail to optimally exchange data and coordinate operations. This failure is a frequent result of applying differing standards or programming paradigms within each manufacturer's data processing system. Interoperating data processing systems offer significant advantages as compared to data processing systems that do not interoperate. The widespread adoption of the World Wide Web is an example of an advantage to developing a uniform standard.

A particular feature of concern is stream support. A stream is a sequence of bytes. In the Windows NT® file system, streams contain the data that is written to a file, and that gives more information about a file than attributes and properties. For example, a stream can be created that contains search keywords, or the identity of the user account that creates a file.

Each stream that is associated with a file has its own allocation size, actual size, and valid data length. The allocation size is the amount of disk space that is reserved for a stream. The actual size is the number of bytes that are being used by a caller. The valid data length (VDL) is the number of bytes that are initialized from the allocation size for the stream.

One or more of these types of streams may store opportunistic locks about a file. In addition, such streams may maintain a sharing mode related to the corresponding file. Other types of data may also be stored to such streams, such as file allocation size, valid data lengths, and the actual size of a file. Some streams store metadata about a file.

Unfortunately, in the area of file systems, significant discontinuities exist in the features offered between manufacturers regarding stream support. A file system is a data structure for storing and maintaining files. The stream feature is an example of a feature in a file system that is not universally implemented.

The problem of uneven implementation of file system features is apparent when a data processing system hosts multiple file systems. Multiple files systems may exist on data processing systems that coexist on a common network. A program operating on files of a first file system may have difficulty accessing all features of the files in a second file system. This difficulty arises for the reason that the developers designed the program only to operate with file systems that offer the functionality and storage capability of a stream. This difficulty is especially apparent when one data processing system provides stream support at one level and a second data processing system provides stream support at another level or does not provide stream support at all.

### SUMMARY OF THE INVENTION

Illustrative embodiments provide a computer implemented method, apparatus, and computer usable program code for supporting a stream. A stream request is received. A file name associated with the stream is created. Responsive to receiving the stream request, the stream is stored as a file in a directory tree in the file system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a table showing examples of file system classes and examples of specific file systems within those classes;

FIG. 4 is a block diagram of a referencing mechanism by which varying file systems may emulate a stream in accordance with an illustrative embodiment;

FIG. 5 is a block diagram of an alternate referencing mechanism by which varying file systems may emulate a stream in accordance with an illustrative embodiment;

FIG. 6 is a sequence of communications in accordance with an illustrative embodiment;

FIG. 7 is an example of a stream naming convention in a unique inode handling file system in accordance with an illustrative embodiment;

FIG. 8 is an example of actual stream names within a directory tree in accordance with an illustrative embodiment;

FIG. 9 is a second example of a stream naming convention in accordance with an illustrative embodiment;

FIG. 10 is a flowchart of steps initializing a file system to handle streams in accordance with an illustrative embodiment;

FIG. 11 is a flowchart of a portion of a process to handle a stream action in accordance with an illustrative embodiment;

FIG. 12 is a flowchart of a further portion of a process to handle a stream action in accordance with an illustrative embodiment; and

FIG. 13 is a flowchart of a further portion of a process to handle a stream action in accordance with an illustrative embodiment.

### DETAILED DESCRIPTION OF THE PREFERRED EMBODIMENT

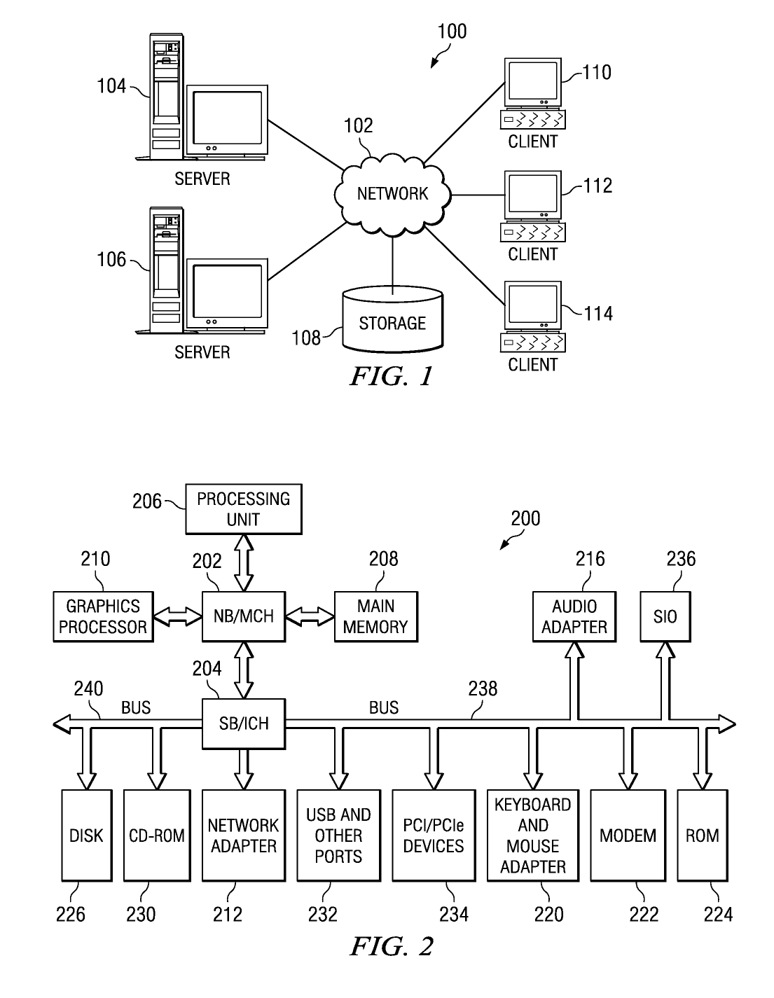

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

FIG. 2 is a block diagram of a data processing system in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide a computer implemented method, apparatus, and computer usable program code for emulating support of streams in file systems that do not support streams or do not fully support streams. Consequently, programs can better access files across a network of heterogeneous file systems by adding stream emulation to those files systems currently without streams capability. The illustrative embodiments may be implemented in a data processing system, such as data processing system 100 shown in FIG. 1 or data processing system 200 shown in FIG. 2.

In particular, the illustrative embodiments shown herein provide for a computer implemented method, apparatus, and computer usable program code for supporting a stream. A stream request is received. In an illustrative example, the stream request is received at a serving system. A file name associated with the stream is created. In response to receiving the stream request, the stream is stored as a file in a directory tree in the file system. In an illustrative example, the file and the file system are associated with the serving system. A serving system is any data processing system suitable for manipulating files, such as data processing system 200 shown in FIG. 2 or data processing systems 104, 106, 108, 110, 112, and 114 shown in FIG. 1.

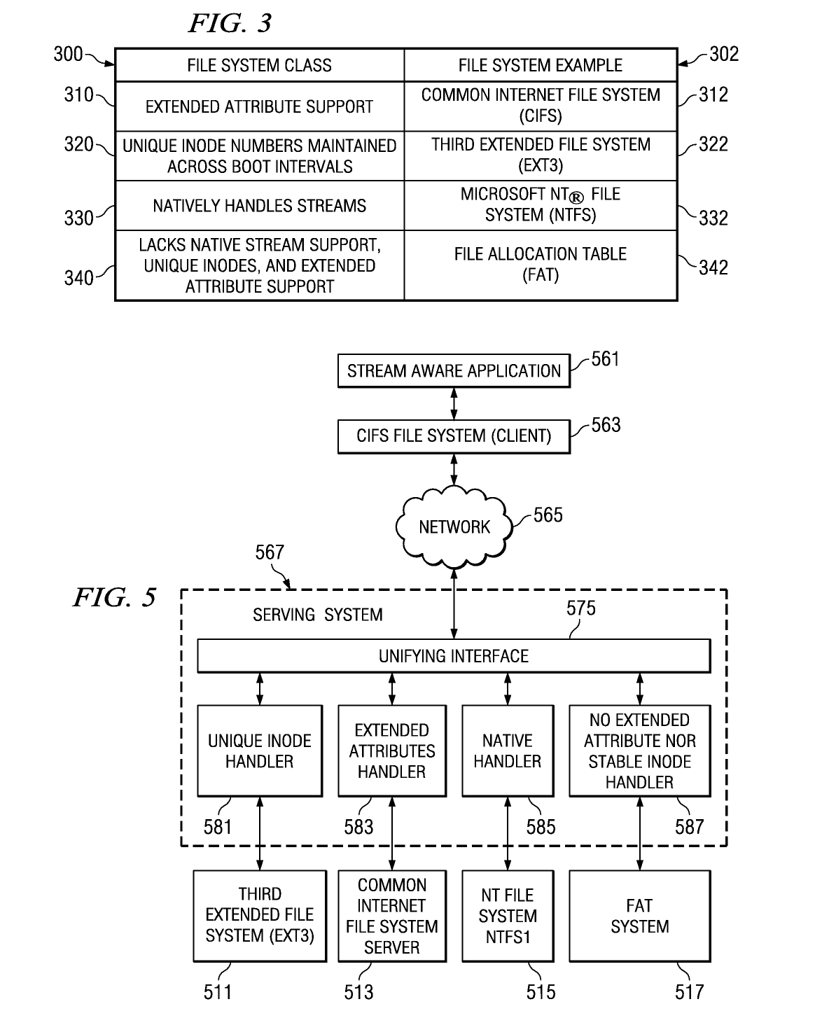

FIG. 3 is a table showing examples of file system classes and examples of specific file systems within those classes. Each file system class and corresponding file system example provide different levels of stream support. Each file system can be implemented in a data processing system, such as data processing system 200 shown in FIG. 2 or data processing systems 104, 106, 108, 110, 112, and 114 shown in FIG. 1.

To better recognize the need for stream support, the illustrative embodiments recognized a number of features of streams. Although a stream may be related to a file, the stream is not the file, but rather a set of data that comprise various parameters associated with the file. Thus, a file may exist without a stream; however, a stream may not exist without an associated file. At the simplest level, a stream is additional data associated with a file system object.

Among the features of a stream is an offset. An offset may be zero or more bits from a beginning or end of the sequence. In other words, a data processing system may randomly access a stream based on a selected offset, without any requirement or attendant delay of reading bits prior to the offset.

A similar but distinct concept to a stream is a piped stream. A piped stream includes a sequence of ordered bytes that permit access to an offset only following a read of all bytes in sequence prior to that offset. The stream and the piped stream differ in that the former does not necessarily read bits prior to the offset before reading bits at the offset.

An example of a stream is found in the Microsoft NT® File System, which corresponds to NT file system 332. Microsoft NT® File system is an example of file system class 330 that natively handles streams. An alternate data stream is a feature that is present in this file system. For example, within an NT File System, a user may add the text “hello” to a file called “stream.txt”. The user may later add the text “there” to an alternate data stream “file.txt:hidden_stream”. Most users may easily retrieve the data “hello” by using Microsoft™ notepad. However, notepad only shows the text “hello” as the contents of the file. Notepad does not access the stream “file.txt:hidden_stream” associated with the file “file.txt”. Nevertheless, many programs use streams. The ability to support streams across file systems is useful.

In all, there exist four file system classes, at least as far as streams are concerned. The first file system class shown is class 310, which provides extended attribute support. An example of class 310, which provides extended attribute support, is common internet file system 312 (CIFS). An extended attribute, or xattr, is a property of a file, consisting of a name and data. Extended attributes exist on some file systems as user attributes. A file system that supports extended attributes can be Solaris™ Unix File Systems (UFS). Solaris is a trademark or registered trademark of Sun Microsystems, Inc. in the U.S. and other countries.

The second file system class shown is class 320, which provides unique inode numbers maintained across boot intervals. An example of class 320, which provides unique inode numbers maintained across boot intervals is third extended file system 322 (ext3). An inode is a data structure that stores information about a file, directory, or other file system object. Thus, an inode number is a number that identifies a particular inode.

The third file system class shown is class 330, which natively handles streams. An example of class 330, which natively handles streams, is Microsoft NT® file system 322. At the simplest level, a stream is additional data associated with a file system object. A stream can also have other properties, as described above.

The fourth file system class shown is class 340, which lacks native stream support, unique inodes, and extended attributes. An example of class 340, which lacks native stream support, unique inodes, or extended attribute support, is file allocation table 342 (FAT), which is an older file system.

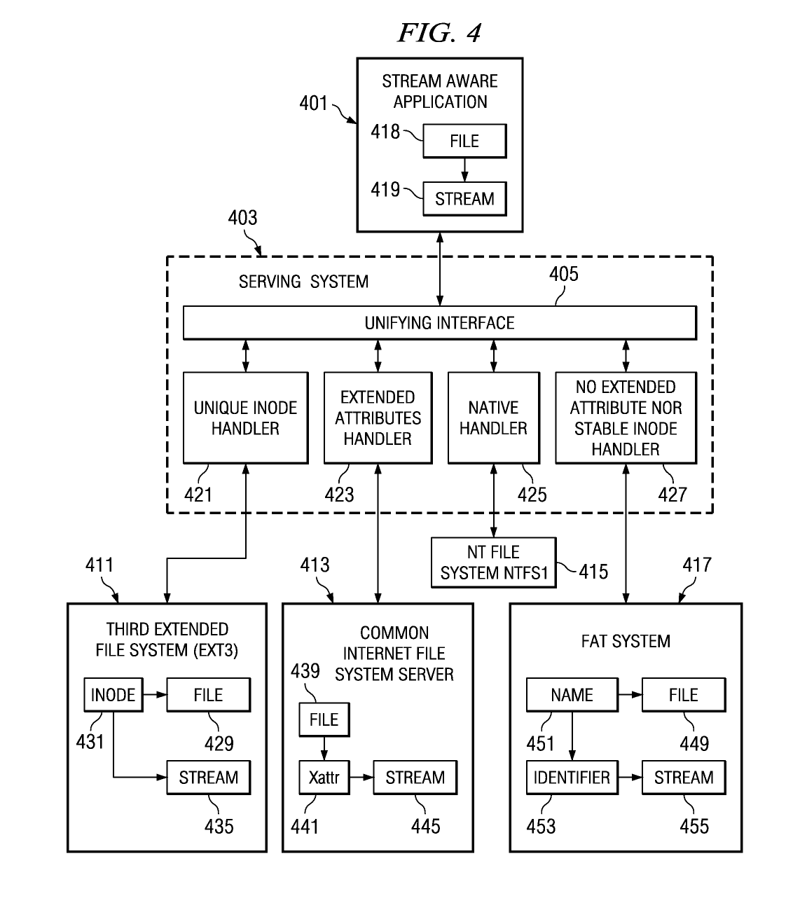

FIG. 4 is a block diagram of a referencing mechanism by which varying file systems may emulate a stream in accordance with an illustrative embodiment. As shown herein, a requesting client application is stream aware application 401. In these examples, a stream aware application is an application that accesses data stored within a stream, and a requesting client application is an application that requests a stream. Stream aware application 401 executes on a data processing system. For example, a data processing system can be data processing system 200 of FIG. 2 running a Linux operating system. Linux is a trademark of Linus Torvalds.

FIG. 4 shows four examples of file systems. The file systems shown in FIG. 4 are third extended file system (ext3) 411 (which corresponds to third extended file system 322 in FIG. 3), common internet file system server (CIFS) 413 (which corresponds to NT file system 312 in FIG. 3), NT File System (NTFS) 415 (which corresponds to NT file system 332 in FIG. 3), and File Allocation Table (FAT) 417 (which corresponds to file allocation table system 342 in FIG. 3). Each file system represents an example of a class of file system according to Table 1 below. Serving system 403 may access each file system through software components including unique inode handler 421, extended attributes handler 423, native handler 425, and no extended attribute nor stable inode handler 427, respectively.

In order to support the stream features of stream aware application 401, each file system references or associates a stream with a corresponding file. For example, inode number 431 references primary file 429 in a file system supporting unique inode numbers, such as third extended file system 411. Third extended file system uses inode number 431 to refer to stream 435. Stream 435 is a file serving as a stream, or a stream file. Thus, a stream file is a data structure that is associated with a file and is seekable to a selected offset from the beginning of the sequence. In this case, stream 435 is associated with file 429. Stream 435 is a stream file because stream 435 has the characteristics of a stream from the perspective of stream aware application 401.

As another example, support for streams is provided in a file system that supports extended attributes, such as common internet file system server 413. In common internet file system server 413 primary file 439 has an inode number. The file system copies the inode number into extended attribute 441 of primary file 439. Again, stream 445 is a file serving as a stream.

In yet another example, a file allocation table (FAT) system stores primary file 449 with name 451 that references primary file 449. File allocation table system converts name 451 to identifier 453 that references stream 455. Again, stream 455 is a file serving as a stream. In each of the examples shown, unifying interface 405 may transmit a file reference to the respective stream to any requesting client application, for example, stream aware application 401.

From a perspective of stream aware application 401, file 418 is associated with stream 419. The stream aware application includes code or computer instructions that permit the stream aware application to perform operations on a stream. This feature makes the application stream aware.

Stream aware application 401 operates as a client with respect to unifying interface 405. Unifying interface 405 may be software that executes on serving system 403 in order to handle requests by clients for stream related operations. The stream aware application keeps a data structure or uses a convention that identifies the relationship between the entities of the file and the stream. The relationship of a file having an associated stream exists regardless of whether file 418 is stored locally to a stream aware application, or file 418 is stored on a remote system and virtually available to stream aware application 401.

On the other hand, an application that is not stream aware stores the data structures differently. For example, an application that is not stream aware is third extended file system 411. From the perspective of an application that is not stream aware, a first file or primary file 429 offers storage consistent with stream aware application's file 418. Also from the perspective of an application that is not stream aware, a second file or stream 435 offers storage consistent with the stream aware application's stream. Unlike stream aware application 401, the application that is not stream aware indirectly associates a file with a stream file. In the case of third extended file system 411, the application that is not stream aware uses an intermediary structure, such as inode 431. An inode is a data structure that stores information about a file, directory, or other file system object. By use of an inode, third extended file system 411 associates a file with a second file such that the second file emulates a stream.

Stream requests can be made from or by stream aware application 401 to a variety of file systems, such as file systems 411, 413, 415, and 417 through serving system 403. A stream request is a request, made by a stream aware application, to a serving system. The stream request is received by a serving system. The serving system performs an operation on at least one stream in response to receiving the stream request, including the operation of creating a stream. The stream may be a file that serves as a stream. The file serves as a stream because the serving system places data into the file that is associated with a second file. The client may store references to both the second file and the file that serves as a stream.

A serving system can respond to stream requests in a number of manners. Serving system 403, which can be data processing system 200 of FIG. 2, may select an appropriate file system of file systems 411, 413, 415, and 417 and forward a stream request to the appropriate file system. Furthermore, serving system 403 accepts a response from the appropriate file system, and returns the response to the client. The client may be stream aware application 401.

Additionally, serving system hosts unifying interface 405. Unifying interface 405 may delegate execution to software modules for specialized handling, depending on the nature of the file system that the stream request describes.

FIG. 5 is a block diagram of an alternate referencing mechanism by which varying file systems may emulate a stream in accordance with an illustrative embodiment. FIG. 5 shows stream aware application 561 accessing a file system, such as file systems 511, 513, 515, and 517 via network 565. Stream aware application 561 corresponds to stream aware application 401 of FIG. 4, serving system 567 corresponds to serving system 403 of FIG. 4, and file systems 511, 513, 515, and 517 correspond to file systems 411, 413, 415, and 417 of FIG. 4 and corresponding file system examples 312, 322, 332, and 342 of FIG. 3. Network 565 can be network 102 of FIG. 1.

In the illustrative example of FIG. 5, stream aware application 561 accesses common internet file system client 563. Nevertheless, stream aware application 561 may identify a second file system as the system where a file physically exists, or is desired to exist. The second file system can communicate through serving system 567. Serving system 567 can be data processing system 200 of FIG. 2. Common internet file system client 563 forwards the stream request over network 565 to serving system 567.

Serving system 567 can be, in a particular example, an extended version of a Samba server. In this example, the serving system extends Samba's server message block (SMB) and common internet file system (CIFS) services. Samba is an open source software package that provides server message block services and common internet file system services. Further information regarding Samba can be found at us5.samba.org/samba.

As with the example shown in FIG. 5, software modules extend serving system 567. Unique inode handler 581 module supports requests for a file. For example, the file may reside on a file system that provides a unique inode number to each file. Extended attributes handler 583 module supports requests for a file that resides on a file system that provides extended attributes. Native handler 585 module supports requests to a system that provides server message block service. No extended attribute nor stable inode handler 587 supports requests for a file that resides on a file system that lacks server message block service, unique inodes, and extended attributes.

The stream request may describe a specific streams-related function. For example, the function may be a request to create a stream, a request to open a stream, or a request to delete a stream. The stream request may include a request to create a file.

Unifying interface 575 selects a software module to handle the request, based on the class of the file system that is the target or serving file system. Unifying interface 575 behaves similarly to unifying interface 405 of FIG. 4. For example, serving file system can be third extended file system 511, common internet file system server 513, NT file system 515, or file allocation table system 517. Similar to FIG. 4, each serving file system may create interconnecting data structures to define an association between a file and a corresponding stream.

Ultimately, serving system 567 completes the stream request according to the procedure appropriate to the file system ultimately having the desired data. Serving system 567 then returns the result of the stream request to stream aware application 561 via network 565.

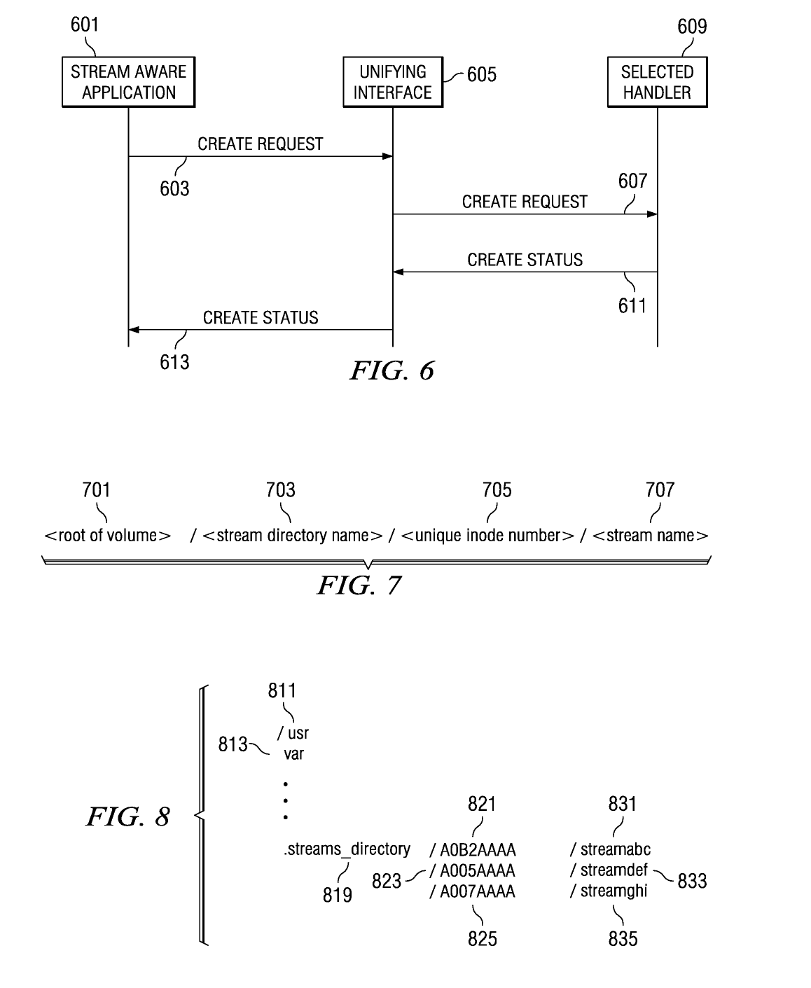

FIG. 6 is a sequence of communications between a stream aware application and a selected handler. The sequence shown in FIG. 6 can be implemented using serving system 403 in FIG. 4 or serving system 567 in FIG. 5. The data processing systems described herein can be implemented using data processing system 200 of FIG. 2. Stream aware application 601 can be stream aware application 401 of FIG. 4 or stream aware application 561 of FIG. 5.

Stream aware application 601 begins the sequence of communications by sending create request 603 to unifying interface 605. For example, create request 603 can be a request to create a file and a stream or to create a file as which the stream can be stored or used.

In response to receiving create request 603, unifying interface 605 communicates create request 613 to selected handler 609. Create request 613 is create request 603, though create request 613 can be formatted by unifying interface 605 for use by selected handler 609. In this illustrative example, selected handler 609 is unique inode handler 421 of FIG. 4.

Next, selected handler 609 obtains a status and potentially a file reference. In this case, the stream aware application is creating a file and a stream. Selected handler 609 transmits create status 611 to unifying interface 605. In this illustrative example, create status 611 includes a file reference, though a file reference is not always needed when communicating create status 611 to unifying interface 605. Selected handler 609 may use an interprocess communication to initiate the step of transmitting.

Finally, unifying interface 603 transmits create status 613 to stream aware application 601. Create status 613 is create status 611, though create status 613 can be formatted by unifying interface 605 for use by stream aware application 501. The process terminates thereafter.

FIG. 7 is an example of a stream naming convention in a unique inode handling file system in accordance with an illustrative embodiment. FIG. 7 is a first example of a format for a stream aspect. The unique inode handling file system is a file system that operates in a data processing system. For example, the data processing system can be data processing system 200 of FIG. 2 using third extended file system 411 of FIG. 4. The unique inode handling file system operates cooperatively with unique inode handler 421 in FIG. 4. The unique inode handling file system retains a unique inode assignment to a file following a reboot of the data processing system. An example of a unique inode handling file system is the third extended file system.

A unifying interface, in coordination with a unique inode handler, establishes a file representation of a stream on a unique inode handling file system by modifying the root of volume 701. The unifying interface can be unifying interface 405 of FIG. 4 or unifying interface 575 of FIG. 5. A unifying interface adds stream directory name 703, for example, “.streams_directory,” as a subdirectory to root of volume 701. The unifying interface makes a further subdirectory beneath stream directory name 703. For example, the further directory may be unique inode number 705. In addition, the unifying interface creates or otherwise manipulates a file having a name denoted by stream name 707.

FIG. 8 is an example of actual stream names within a directory tree in accordance with an illustrative embodiment. The stream names, in this example, are those stream names set up in a third extended (ext3) file system. The third extended file system can be, for example, third extended file system 411 of FIG. 4.

File systems, such as the third extended file system, associate inodes with each file. An inode is a data structure that stores information about a file, directory, or other file system object. An inode number is a number or other string that uniquely identifies the inode within the file system that hosts the inode.

Subdirectories of a root volume can include, for example, /usr 811, var 813, and other subdirectories. In these examples, the root is denoted by “/”. A well-known directory may be adopted by convention among manufacturers, such as “.streams_directory” 819. Such a directory includes subdirectories corresponding to inode numbers in a 32-bit file system, namely A0B2AAAA 821, A005AAAA 823, and A007AAAA 825. These subdirectories have a single file within. Each file has a corresponding file name, for example, streamabc 831, streamdef 833, and streamghi 835, respectively. Because each file also serves as a stream, the file names may also be stream names. An inode number subdirectory name can be stored in 4 bytes in this example. Other file systems can use 64-bit inodes, and correspondingly longer subdirectory names.

As explained above, streamabc 831, is a file name. A file name is a string of characters established by the conventions of a file system. The file name uniquely identifies a file within the context of the directory in which the file is located. The fully qualified file path, /.streams_directory/A0B2AAAA, is the concatenation of .streams_directory 819 and A0B2AAAA 821 with an intervening hierarchy separator character, such as ‘/’. A file path is a string of characters that uniquely identifies the directory within which a file is located. The file path also uniquely identifies the name of the file itself. The context is a selected directory in the directory tree. If the context is the root directory, then the file path is a fully qualified file path.

Accordingly, the arrangement of directories and files of FIG. 8 represents an exemplary directory tree in accordance with the stream naming convention of FIG. 7. A directory tree is a data structure that includes at least one directory. A directory tree can include one or more subdirectories below the directory. A subdirectory is another directory contained within a parent directory. The root directory is the base of the directory tree and is the highest parent directory. Thus, directory subordinate to the root directory is a subdirectory with respect to the root directory. Each directory may contain files and further subdirectories. A serving system directory tree is a specific directory tree stored on media of the serving system.

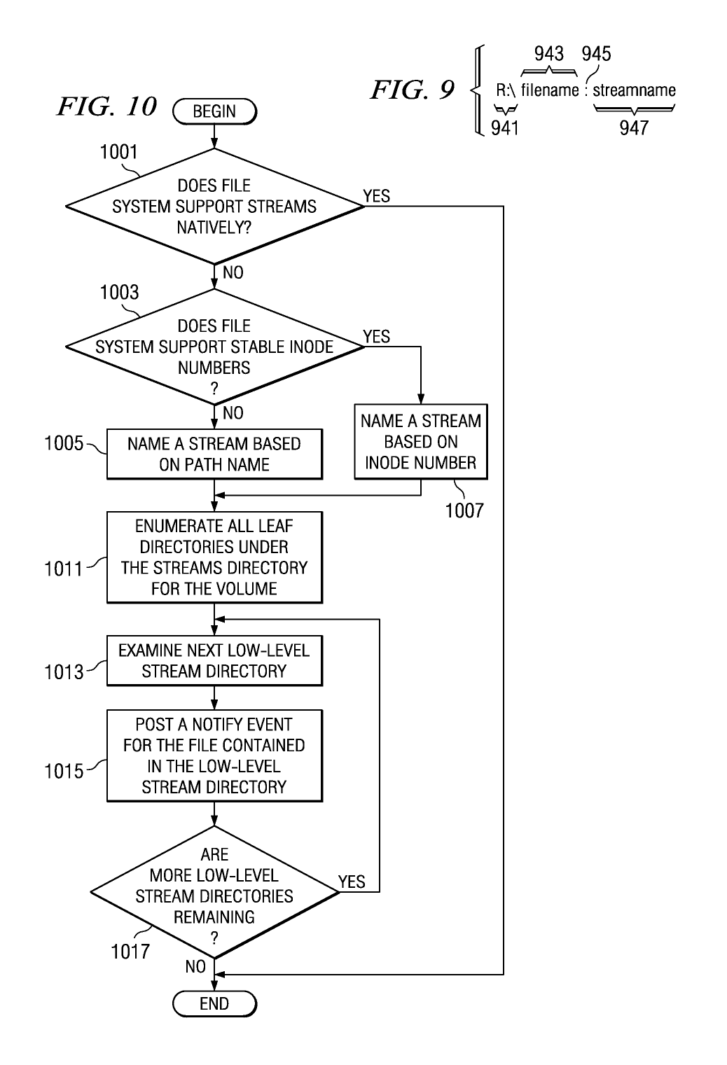

FIG. 9 is a second example of a stream naming convention in accordance with an illustrative embodiment. The second example is for a file system that natively supports streams. An example of a file system that supports streams is the Windows NT® File System. Disk designation 941 forms a root to a file system. A full path to a stream includes disk designation 941, filename 943, separator 945, and stream name 947.

FIG. 10 is a flowchart of steps initializing a file system to handle streams in accordance with an illustrative embodiment. A system administrator configures a unifying interface to emulate streams, if necessary, for a file system. In these illustrative examples, the process in FIG. 10 is implemented in a unifying interface. For example, the unifying interface can be unifying interface 405 of FIG. 4 or unifying interface 575 of FIG. 5.

The process begins as the unifying interface determines whether the file system supports streams natively (step 1001). A positive result to step 1001 prompts the process to terminate, as no further action is needed to provide support for streams. Otherwise, the unifying interface will continue the process to emulate streams, as described further below.

If the file system does not support streams natively, the unifying interface determines whether the file system supports stable inode numbers (step 1003). A positive determination occurs for file systems for which unique inode numbers exist across boot intervals, such as third extended file system. In these types of file systems, the file system keeps an association between a file and an inode number following each reboot. By keeping such an association, the file system causes inode numbers to exist across boot intervals.

A positive determination to step 1003 prompts the unifying interface to name a stream based on the file's inode number (step 1007). However, if the determination of step 1003 is negative, the unifying interface names a stream based on a path name (step 1005).

Next, the unifying interface enumerates all leaf directories under the streams directory for the file system volume (step 1011). The unifying interface examines the next unexamined low-level stream directory (step 1013). A low-level stream directory can be, for example, directory A0B2AAAA 821 of FIG. 8. The unifying interface posts a notify event associated with the file contained in that low-level stream directory (step 1015).

The unifying interface then determines whether any more low-level stream directories remain (step 1017). A positive determination prompts the unifying interface to execute step 1013 and repeat the process from that point. Otherwise, the initialization process terminates.

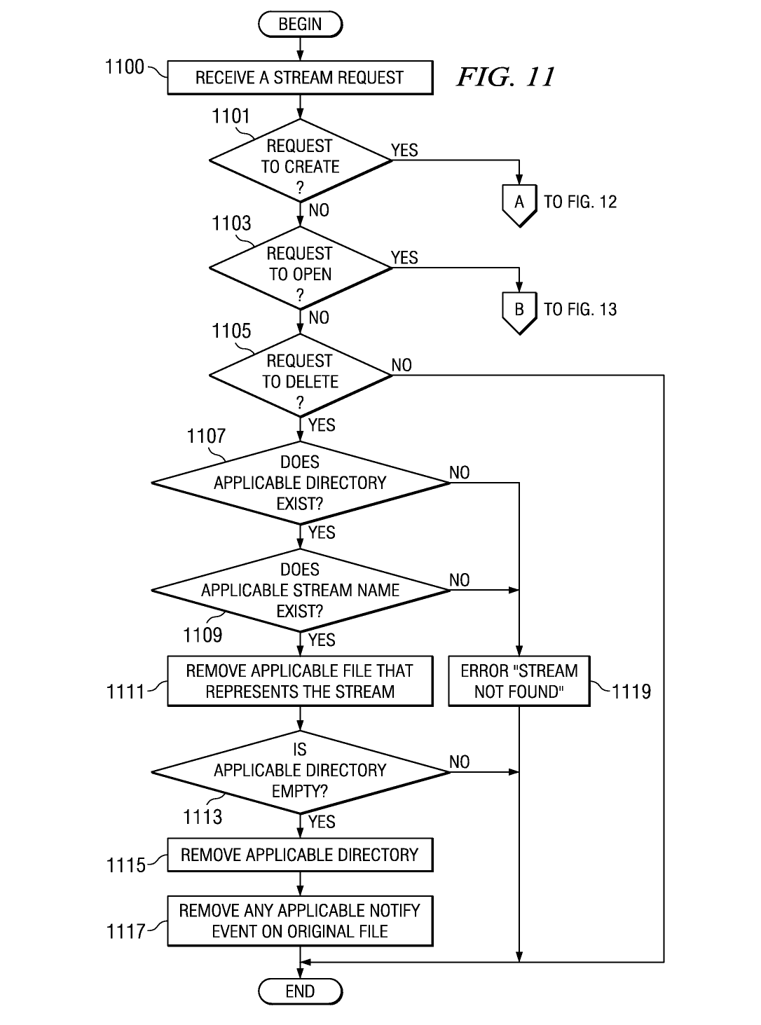

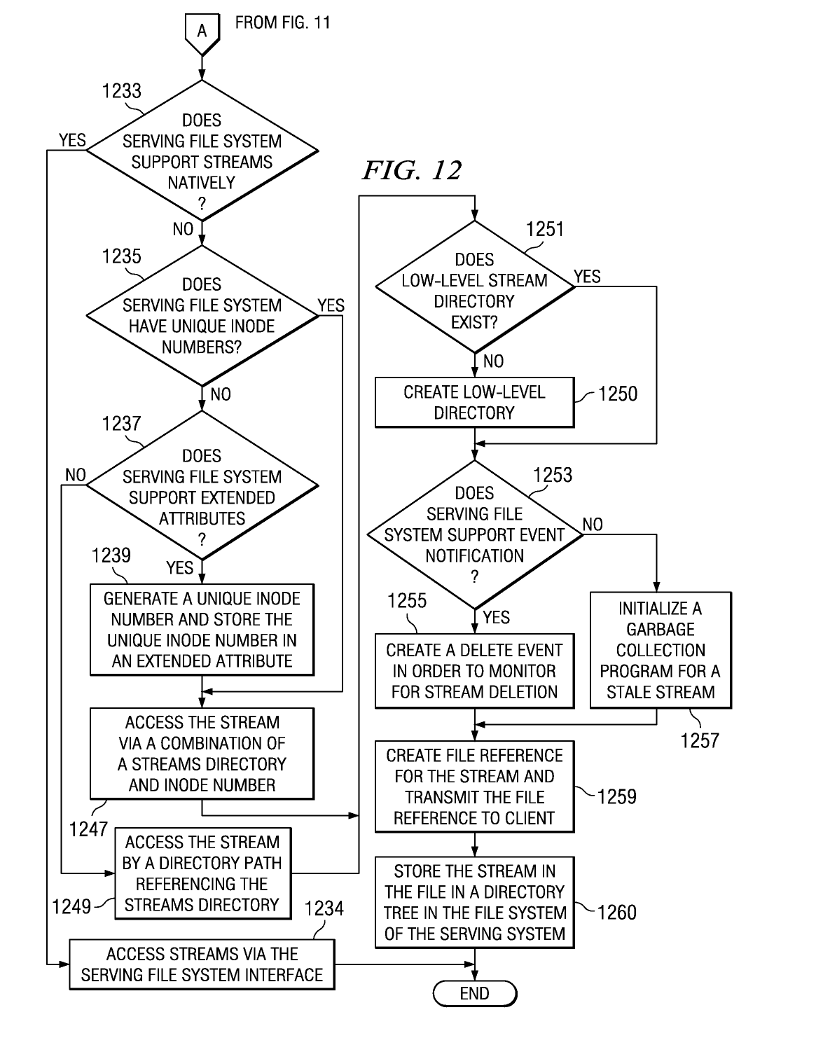

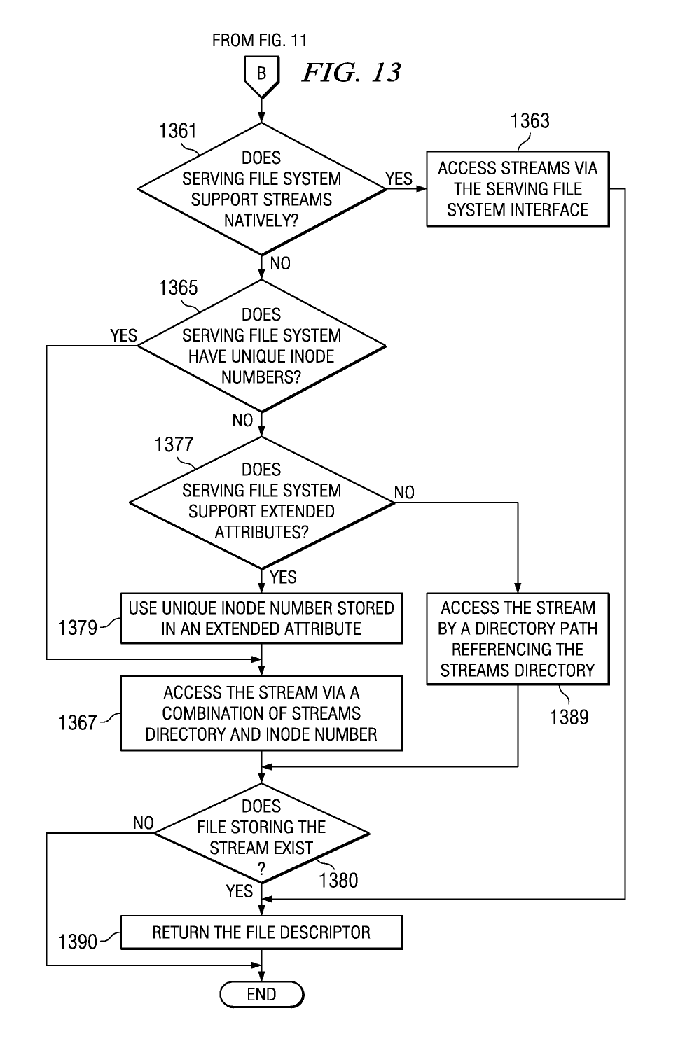

FIG. 11, FIG. 12, and FIG. 13 together form a flowchart of a process to handle a stream action in accordance with an illustrative embodiment. The process shown in these figures can be implemented using a unifying interface, such as unifying interface 405 of FIG. 4 or unifying interface 575 of FIG. 5. The unifying interface can be implemented on a data processing system, such as data processing system 200 of FIG. 2.

Turning now to the individual figures, FIG. 11 is a flowchart of a portion of a process to handle a stream action in accordance with an illustrative embodiment. A unifying interface receives a stream request 1100. The stream request is one of a request to create, a request to open, or a request to delete. A stream request includes a stream aware application passing a file name as an argument to the unifying interface.

Next, the unifying interface determines if the request is a request to create (step 1101). A negative determination prompts the unifying interface to determine if the request is a request to open (step 1103). A negative determination to step 1103 prompts the unifying interface to determine if the request is to delete (step 1105). A negative determination to step 1105 prompts the process to terminate thereafter, as no action vis-à-vis the stream is to be performed.

Provided that the request is to delete at step 1105, the unifying interface determines if the applicable directory exists (step 1107). The applicable directory is a directory that contains the file identified by the file name. If the applicable directory does exist, the unifying interface may determine if a stream name exists according to the conventions of the file system (step 1109). For example, the conventions of the file system can be those conventions shown in FIG. 7. If the unifying interface determines that no applicable directory exists (step 1107) or that no applicable stream name exists (step 1109), then the unifying interface may generate an error, such as “stream not found” (step 1119). The process terminates thereafter.

Provided that a positive determination occurs at step 1109, the unifying interface removes the applicable file that represents the stream (step 1111). For example, the applicable file is stream 435 of FIG. 4. The unifying interface further determines if the applicable directory is empty (step 1113). A negative determination prompts the process to terminate. The process does not terminate because the directory is still needed. The directory is still needed because the directory is not empty as other streams exist for the file.

However, if the applicable directory is empty, the unifying interface removes the applicable directory (step 1115). Finally, the unifying interface removes any applicable notify event on the original file (step 1117). The process terminates thereafter.

FIG. 12 is a flowchart of a further portion of a process to handle a stream action in accordance with an illustrative embodiment. The unifying interface executes the steps of FIG. 12 if the unifying interface detects a request to create at step 1101.

After detecting a request to create at step 1101, the unifying interface determines whether the target or serving file system supports streams natively (step 1233). For example, a positive determination occurs for systems such as the Windows NT® file system. Based on a positive determination, the unifying interface accesses streams via the serving file system's interface (step 1234). For example, the unifying interface may execute step 1234 by passing the stream request directly to a serving file system interface. The file and/or stream is thereafter created, with the the process terminating thereafter.

If the serving file system does not support streams natively, then the unifying interface determines if the serving file system has unique inode numbers (step 1235). A serving file system has unique inode numbers when the serving file system indicates that an inode number assigned to a file remains unchanged following a system reboot. A negative determination to step 1235 prompts the unifying interface to determine whether the serving file system supports extended attributes (step 1237). An extended attribute, or xattr, is a property of a file, consisting of a name and data. Extended attributes exist on some file systems as user attributes. A file system that supports extended attributes can be Solaris™ Unix File Systems (UFS). Solaris is a trademark or registered trademark of Sun Microsystems, Inc. in the U.S. and other countries.

Responsive to a determination that extended attributes are available at step 1237, the unifying interface generates a unique inode number and stores the unique inode number in an extended attribute (step 1239). However, following a negative determination at step 1237, the unifying interface accesses the stream by a directory path referencing the streams directory (step 1249). The process of accessing includes the unifying interface determining a directory path in the directory tree.

Following a positive determination to step 1235, or after execution of step 1239, the unifying interface accesses the stream by a combination of a streams directory and the inode number (step 1247). The unifying interface then determines if a low-level stream directory exists (step 1251). A low-level stream directory is a further subdirectory below the streams directory. For example, the low-level stream directory can be subdirectory 705 of FIG. 7. Responsive to a negative determination at step 1251, the unifying interface creates a low-level stream directory (step 1250).

If the low-level stream directory exists at step 1251 or is created at step 1250, the unifying interface determines if the serving file system supports file system event notification (step 1253). File system event notification may occur based on a supporting mechanism, for example, inotify, dnotify, and other file system event notification methods. If the serving file system supports event notification, the unifying interface creates a delete event in order to monitor for stream deletion (step 1255). A negative determination to step 1253 prompts the unifying interface to initialize a garbage collection program for a stale stream (step 1257).

When the unifying interface creates a delete event, the serving file system associates the primary file with the delete event. The unifying interface may store the delete event in a table. The table may include in each row, for example, a delete event, a corresponding directory of the serving file system, and a requesting client application process or file. For example, the requesting client application can be stream aware application 401 of FIG. 4.

Similarly, third extended file system 411 of FIG. 4 may support inotify. In this case, third extended file system 311 creates a corresponding message, which could be named as a SIGIO signal, in order to report the event of deleting the primary file. This corresponding message is a signal raised in a running application by the operating system kernel when the kernel has prepared a file descriptor for input or output operations. When the unifying interface creates a delete event, the serving file system relays the message to the stream aware application when the serving file system deletes the primary file. The message is associated with the delete event, and thus further associated with the file. For example, the primary file may be file 439 of FIG. 4.

Returning to the process shown in FIG. 12, the unifying interface creates a file reference for the stream and transmits the file reference to the client (step 1259). A file reference is data that defines the file within a stream aware application. A file reference can be a file descriptor. A file descriptor is a pointer that points, directly or indirectly, to a data structure, such as a file. A file descriptor can be a file name and/or a file path in a directory tree.

Next, the unifying interface stores the stream in the file in a directory tree in the file system of the serving system (step 1260). The file is that file associated with the file descriptor. The process terminates thereafter.

FIG. 13 is a flowchart of a further portion of a process to handle a stream action in accordance with an illustrative embodiment. For example, the unifying interface is unifying interface 405 of FIG. 4 or unifying interface 575 of FIG. 5. FIG. 13 includes steps executed in response to a determination that a stream request is a request to open at step 1103 of FIG. 11.

Once the unifying interface receives a request to open, the unifying interface determines if the serving file system supports streams natively (step 1361). A positive determination occurs, for example, for file systems such as Windows NT®. Based on a positive determination, the unifying interface passes the stream request directly to a serving file system interface in order to access streams via the serving file system's interface (step 1363). The unifying descriptor then returns the file descriptor to the requesting application (step 1390), with processing terminating thereafter.

If the serving file system does not support streams natively, then the unifying interface determines if the serving file system has unique inode numbers (step 1365). A positive determination at step 1365 causes unifying interface to access the stream by a combination of a streams directory and the inode number (step 1367).

If the serving file system does not have unique inode numbers at step 1365, then the unifying interface determines whether the serving file system supports extended attributes (step 1377). A positive determination to step 1377 prompts the unifying interface to use a unique inode number stored in an extended attribute (step 1379). Thereafter, the unifying interface accesses the stream by a combination of a streams directory and the inode number (step 1367). On the other hand, responsive to a negative determination at step 1377, the unifying interface accesses the stream by a directory path referencing the streams directory (step 1389).

The steps of step 1389 and step 1367 provide a unique file reference, whereby the unifying interface may open a file that emulates a stream. Once the unique file reference is determined, the unifying interface determines whether a file storing the stream exists (step 1380). A positive determination prompts the unifying interface to return the file descriptor (step 1390), with the process terminating thereafter. Likewise, a negative determination at step 1380 prompts the process to terminate.

Thus, the aspects of the illustrative embodiments provide a computer implemented method, apparatus, and computer usable program code for an interface to respond to stream requests from a stream aware application. In these illustrative examples, the interface is a unifying interface. This interface matches a new file to a primary file such that the new file is referenced with a unique file reference. The unifying interface transmits the file reference to the stream aware client, permitting further operations on the stream emulated as the new file. Consequently, a stream-aware application may access a stream across heterogeneous file systems.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for supporting a stream in a file system comprising:
receiving a stream request;
creating a file name associated with the stream; and
responsive to receiving the stream request, storing the stream as a file in a directory tree in the file system.

2. The computer implemented method of claim 1 further comprising:
transmitting a file reference to a requesting client application.

3. The computer implemented method of claim 2 further comprising:
determining a file path in the directory tree for the file reference.

4. The computer implemented method of claim 1 further comprising:
determining whether a serving system associated with the file system supports extended attributes; and
wherein the step of creating comprises:
generating an inode number associated with a primary file;
responsive to a determination that the serving system supports extended attributes, storing the inode number in an extended attribute; and
creating a subdirectory based on the inode number.

5. The computer implemented method of claim 1 further comprising:
determining whether a serving system associated with the file system supports unique inode numbers; and
wherein the step of creating comprises:
creating a subdirectory based on an inode number associated with a primary file, wherein the file name comprises the subdirectory.

6. The computer implemented method of claim 1 further comprising:
determining whether a serving system associated with the file system supports file system event notification;
responsive to a determination that the serving system supports file system event notification, creating a delete event, wherein the delete event associates the file with a stream file and the file is a primary file;
receiving a message associated with the file; and
removing the stream file.

7. The computer implemented method of claim 1 wherein the steps are executed using unifying interface.

8. A computer program product comprising:
a computer usable medium having computer usable program code for supporting a stream in a file system, said computer program product including:
computer usable program code for receiving a stream request;
computer usable program code for creating a file name associated with the stream; and
computer usable program code for, responsive to receiving the stream request, storing the stream as a file in a directory tree in the file system.

9. The computer program product of claim 8 further comprising:
computer usable program code for transmitting a file reference to a requesting client application.

10. The computer program product of claim 9 further comprising:
computer usable program code for determining a file path in the directory tree for the file reference.

11. The computer program product of claim 8 further comprising:
computer usable program code for determining whether a serving system associated with the file system supports extended attributes; and
wherein the computer usable program code for creating comprises:
computer usable program code for generating an inode number associated with a primary file;
computer usable program code for, responsive to a determination that the serving system supports extended attributes, storing the inode number in an extended attribute; and
computer usable program code for creating a subdirectory based on the inode number.

12. The computer program product of claim 8 further comprising:
computer usable program code for determining whether a serving system associated with the file system supports unique inode numbers; and
wherein the computer usable program code for creating comprises:
computer usable program code for creating a subdirectory based on an inode number associated with a primary file, wherein the file name comprises the subdirectory.

13. The computer program product of claim 8 further comprising:
computer usable program code for determining whether a serving system associated with the file system supports file system event notification;
computer usable program code for, responsive to a determination that the serving system supports file system event notification, creating a delete event, wherein the delete event associates the file with a stream file and the file is a primary file;
computer usable program code for receiving a message associated with the file; and
computer usable program code for removing the stream file.

14. The computer program product of claim 8 wherein the computer usable program code comprises a unifying interface.

15. A data processing system comprising:
a processor;
a bus connected to the processor;
a computer usable medium connected to the bus, wherein the computer usable medium contains a set of instructions for supporting a stream in a file system, wherein the processor is adapted to carry out the set of instructions to:
receive a stream request;
create a file name associated with the stream; and
responsive to receiving the stream request, store the stream as a file in a directory tree in the file system.

16. The data processing system of claim 16 wherein the processor is further adapted to carry out the set of instructions to:
transmit a file reference to a requesting client application.

17. The data processing system of claim 16 wherein the processor is further adapted to carry out the set of instructions to:
determine a file path in the directory tree for the file reference.

18. The data processing system of claim 15 wherein the processor is further adapted to carry out the set of instructions to:
determine whether a serving system associated with the file system supports extended attributes; and
wherein the processor carries out the set of instructions to create by carrying out the set of instructions to:
generate an inode number associated with a primary file;
responsive to a determination that the serving system supports extended attributes, store the inode number in an extended attribute; and
create a subdirectory based on the inode number.

19. The data processing system of claim 15 wherein the processor is further adapted to carry out the set of instructions to:
determine whether a serving system associated with the file system supports unique inode numbers; and
wherein the processor carries out the set of instructions to create by carrying out the set of instructions to:
create a subdirectory based on an inode number associated with a primary file, wherein the file name comprises the subdirectory.

20. The data processing system of claim 15 wherein the processor is further adapted to carry out the set of instructions to:
determine whether a serving system associated with the file system supports file system event notification;
responsive to a determination that the serving system supports file system event notification, create a delete event, wherein the delete event associates the file with a stream file and the file is a primary file;
receive a message associated with the file; and
remove the stream file.
